(19) United States
(12) Patent Application Publication
(10) Pub. No.: US 2006/0290717 A1
(43) Pub. Date: Dec. 28, 2006

(54) Display apparatus, information processing apparatus, and method for controlling display apparatus

(75) Inventors: Ryoji Ninomiya, Tachikawa-shi (JP); Norikazu Nagasawa, Ome-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/473,000

(22) Filed: Jun. 23, 2006

(30) Foreign Application Priority Data
Jun. 24, 2005 (JP) 2005-185243

(51) Int. Cl. G09G 5/10

(52) U.S. Cl. 345/690

(57) ABSTRACT

According to one embodiment, a display apparatus includes an input unit configured to input any one of display data in m-bit gradation in each color and display data in n(m>n)-bit gradation in each color, a display control unit configured to execute display control of display data inputted by the input unit in m-bit gradation in each color, a determination unit configured to determine whether the display data inputted by the input unit is in m-bit gradation in each color or in n-bit gradation in each color, and a mask unit configured to execute mask processing for making a control to display the display data in n-bit gradation in each color as the display data in m-bit gradation in each color on the display control unit, when the display data is determined to be in n-bit gradation in each color by the determination unit.

### CROSS-REFERENCE TO RELATED APPLICATIONS

This application is based upon and claims the benefit of priority from Japanese Patent Application No. 2005-185243, filed Jun. 24, 2005, the entire contents of which are incorporated herein by reference.

### BACKGROUND

1. Field

One embodiment of the invention relates to a display control technology for making it possible to x correspond to both of, for example, an interface for transmitting and receiving display data in 6-bit gradation in each color and an interface for transmitting and receiving display data in 8-bit gradation in each color.

2. Description of the Related Art

In recent years, personal computers of a notebook type, a desktop type, and the like have been broadly popularized. At first, liquid crystal displays (LCDs) are display apparatuses mainly mounted on personal computers of a notebook type. Recently, however, LCDs have become mainstream as display apparatuses utilized for personal computers of a desktop type.

The performances of the LCDs have been improved year by year, and an output level of each color of R (red), G (green) and B (blue) has come in predisposed to be multiple gradation, i.e., to be in a great number of colors. Further, LCDs whose number of display colors can be changed in response to a request of each user have been developed (for example, refer to Japanese Patent Application Publication (KOKAI) No. 8-87002).

By the way, it is effective without doubt that 6-bit gradation in each color and 8-bit gradation in each color can be properly used in response to a user's request. However, a prior art has a mechanism for carrying out display control in 6-bit gradation after being equipped with a shared interface capable of transmitting and receiving display data in 8-bit gradation in each color, and does not correspond to a computer having only an interface which outputs display data in 6-bit gradation in each color.

An attempt is made, not only to make LCDs have a great number of colors, but also, for example, to speed up the operations thereof, and the like variously as improvements in the performances of LCDs. For this reason, there are many requests to apply a new type of computer having an interface for inputting display data in 8-bit gradation also to an old-model computer and a low-priced model computer having an interface for outputting display data in 6-bit gradation in each color, for example.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary outline view of an information processing apparatus according to one embodiment of the present invention;

FIG. 2 is an exemplary functional block diagram relating to data display of a computer of the embodiment in which a computer main unit having an interface for outputting display data in 8-bit gradation in each color and a display unit are connected to each other;

FIG. 3 is an exemplary functional block diagram relating to data display of a computer of the embodiment in which a computer main unit having an interface for outputting display data in 6-bit gradation in each color and a display unit are connected to each other;

FIG. 4 is a diagram showing one exemplary configuration of an IF control circuit of the embodiment;

FIG. 5 is an exemplary flowchart showing operational procedures relating to data display of the computer according to the embodiment; and

FIG. 6 is an exemplary flowchart showing operational procedures (a modified example) relating to data display of the computer according to the embodiment.

### DETAILED DESCRIPTION

Various embodiments according to the invention will be described hereinafter with reference to the accompanying drawings. In general, according to one embodiment of the invention, a display apparatus includes an input unit configured to input any one of display data in m-bit gradation in each color and display data in n(m>n)-bit gradation in each color, a display control unit configured to execute display control of display data inputted by the input unit in m-bit gradation in each color, a determination unit configured to determine whether the display data inputted by the input unit is in m-bit gradation in each color or in n-bit gradation in each color, and a mask unit configured to execute mask processing with respect to the display data in n-bit gradation in each color, and the determination unit controlling the display data in n-bit gradation in each color as the display data in m-bit gradation in each color on the display control unit, when the display data is determined to be in n-bit gradation in each color by the determination unit.

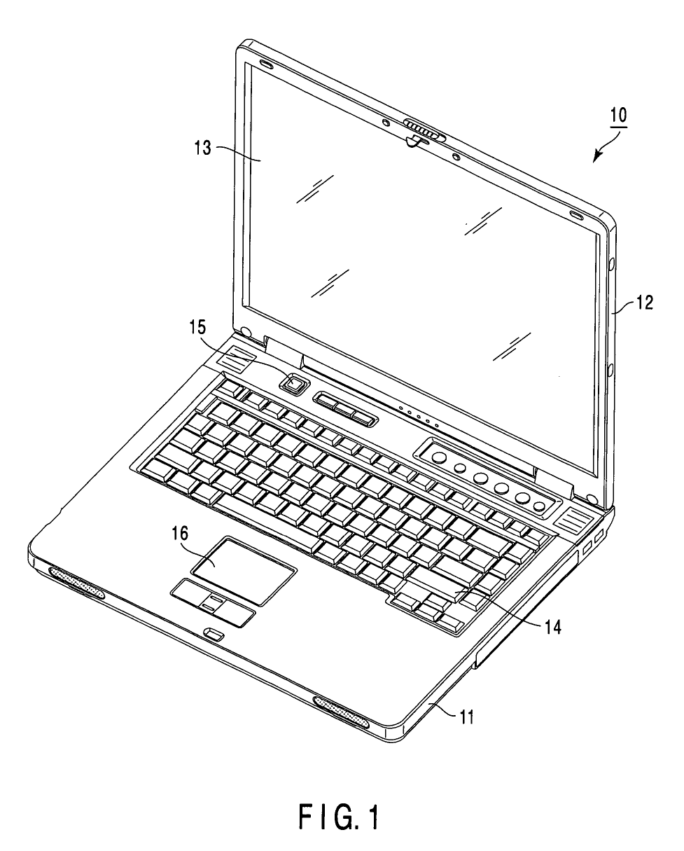

FIG. 1 is an exemplary outline view of an information processing apparatus according to one embodiment of the present invention. As shown in FIG. 1, the information processing apparatus is realized as a personal computer 10 of a notebook type.

The computer 10 is configured by a computer main unit 11 and a display unit 12. A display device composed of a liquid crystal display (LCD) 13 is built into the display unit 12, and a display screen of the LCD 13 is positioned in substantially the center of the display unit 12.

The display unit 12 is attached to the computer main unit 11 so as to be freely rotatable between an open position and a closed position. Further, the computer main unit 11 has a thin box housing, and on the top surface thereof, a keyboard 14, a power button 15 for turning the computer 10 on/off, a touch pad 16, and the like are arranged.

Then, the display unit 12 of the computer 10 having such an appearance is made possible to correspond to both of, for example, a high-performance model computer main unit 11 which has an interface capable of outputting display data in 8-bit gradation in each color, and for example, a low-priced model computer main unit 11 which has only an interface for outputting display data in 6-bit gradation in each color, and hereinafter, this point will be described in detail.

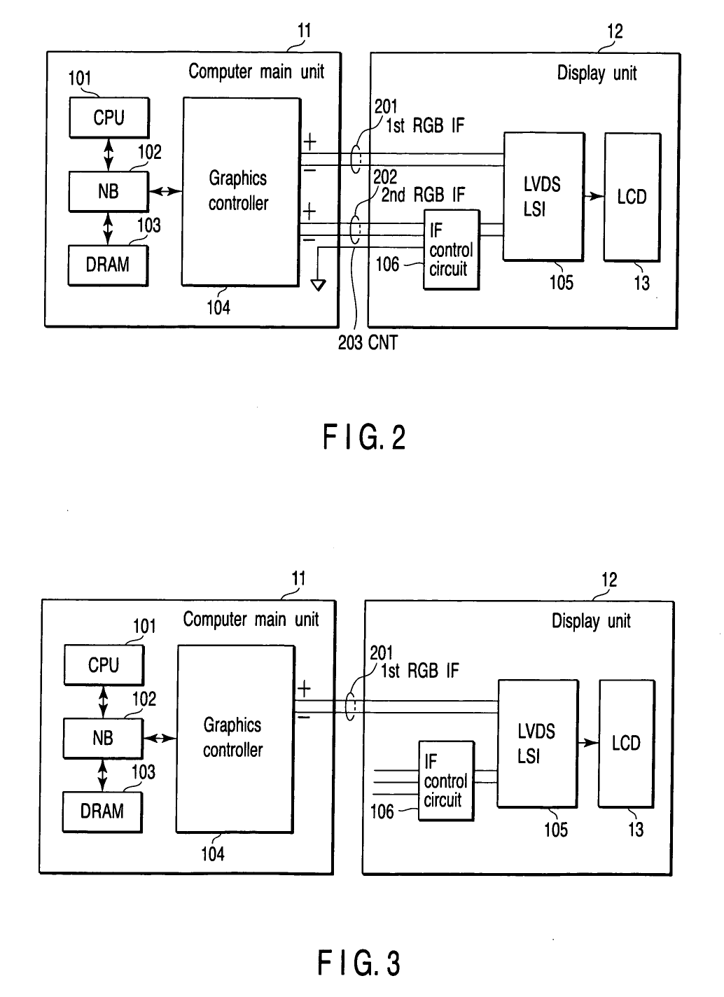

FIG. 2 is an exemplary functional block diagram relating to data display of the computer 10 in which the computer main unit 11 having an interface which outputs display data in 8-bit gradation in each color and the display unit 12 are connected to each other.

The computer main unit 11 has a CPU 101, a north bridge (NB) 102, a DRAM 103, and a graphics controller 104.

The CPU 101 is a processor for controlling operations of the computer 10, and executes an operating system and various application programs including and utilities which are stored in the DRAM 103. The NB 102 is a bridge device for connecting a local bus of the CPU 101 to a system bus. A memory controller for access-controlling the DRAM 103 is also built in the NB 102. Further, the NB 102 has a function of communicating with the graphics controller 104 via an accelerated graphics port (AGP) bus, a serial bus according to the PCI express standard, and the like. Then, the graphics controller 104 is a display controller which generates display data of a program executed by the CPU 101, and transmits the generated display data to the display unit 12.

On the other hand, the display unit 12 has, in addition to the LCD 13 shown in FIG. 1, an LVDS LSI 105 and an interface (IF) control circuit 106.

The LVDS LSI 105 makes a control to display the display data received from the graphics controller 104 of the computer main unit 11 on the LCD 13 in 8-bit gradation in each color. The IF control circuit 106 determines whether the display data transmitted form the graphics controller 104 of the computer main unit 11 is display data in 8-bit gradation in each color or display data in 6-bit gradation in each color. If it is display data in 6-bit gradation in each color, the IF control circuit 106 executes mask processing for making a control to display the display data in 6-bit gradation in each color on the LVDS LSI 105 as the display data in 8-bit gradation in each color.

Here, because it is premised that the computer main unit 11 has an interface which outputs display data in 8-bit gradation in each color, the graphics controller 104 outputs each data of R (red), G (green) and B (blue) serially every 8 bits by a differential signal. At this time, the graphics controller 104 outputs data of the high 6 bits among the display data of 8 bits in each of R, G and B to a 1st RGB IF 201, and outputs the remaining data of the low 2 bits to a 2nd RGB IF 202. Further, in the computer main unit 11, a CNT signal line 203 is connected to ground so as to make a signal level Low.

The data of the high 6 bits outputted to the 1st RGB IF 201 is directly inputted to the LVDS LSI 105. On the other hand, the data of the low 2 bits outputted to the 2nd RGB IF 202 is inputted to the LVDS LSI 105 via the IF control circuit 106. The IF control circuit 106 monitors a signal level on the CNT signal line 203. If a signal level is Low, any processing is not applied, and the data of the low 2 bits is relayed to the LVDS LSI 105 directly so as to have the value as is.

Namely, the 8-bit data outputted to be separated to the 1st RGB IF 201 and the 2nd RGB IF 202 is supplied to the LVDS LSI 105 in the original form in the event, and is to be controlled to be displayed as display data in 8-bit gradation in each color.

On the other hand, FIG. 3 is an exemplary functional block diagram relating to data display of the computer 10 in which the computer main unit 11 having an interface which outputs display data in 6-bit gradation in each color and the display unit 12 are connected to each other.

In the graphics controller 104 of the computer main unit 11, each data of R (red), G (green) and B (blue) is serially outputted every 6 bits by a differential signal. At this time, the graphics controller 104 outputs display data of 6 bits in each of R, G and B to the 1st RGB IF 201. Further, in the computer main unit 11, the CNT signal line 203 for making a signal level Low is not grounded.

The IF control circuit 106 of the display unit 12 executes the mask processing described above when a signal level on the CNT signal line 203 is not Low, but OPEN. To describe this mask processing more specifically, a case in which a signal level on the CNT signal line 203 is OPEN means that there is no data output to the 2nd RGB IF 202, and thus, a+side of a differential signal is fixed to a High level and a−side is fixed to a Low level so as to make the signal level stable. Consequently, the data of the 2nd RGB IF 202 which reaches the LVDS LSI 105 via itself is fixed to 0. Namely, the low 2 bits in the 8-bit data to be inputted by the LVDS LSI 105 are masked with 0.

In accordance with the action of the IF control circuit 106, the LVDS LSI 105 does not have to know at all whether the computer main unit 11 has an interface which outputs display data in 8-bit gradation in each color, or has an interface which outputs display data in 6-bit gradation in each color. In addition, in accordance with the action of the IF control circuit 106, it is possible to apply the new type of display unit 12 having an interface for inputting display data in 8-bit gradation to, for example, not only the new type of computer main unit 11 which has an interface for outputting display data in 8-bit gradation in each color, but also an old-model computer or a low-priced model computer which has an interface for outputting display data in 6-bit gradation in each color.

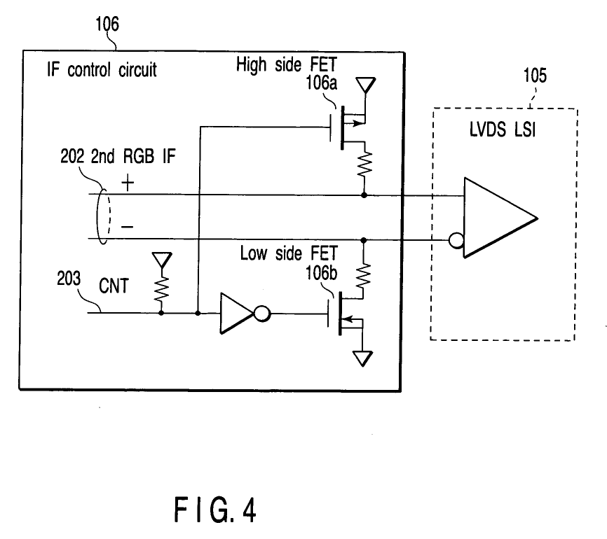

FIG. 4 is a diagram showing one exemplary configuration of the IF control circuit 106.

With the configuration shown in FIG. 4, both of a High Side FET 106a and a Low Side FET 106b are turned off when a signal level on the CNT signal line 203 is Low. As a result, the data outputted to the 2nd RGB IF signal line 202 is supplied to the LVDS LSI 105 so as to have the value as is.

When a signal level on the CNT signal line 203 is OPEN, on the other hand, both of the High Side FET 106a and the Low Side FET 106b are turned on, and a signal level is fixed such that the data on the 2nd RGB IF signal line 202 which supplies data of the low 2 bits out of the 8 bits to the LVDS LSI 105 is masked with 0.

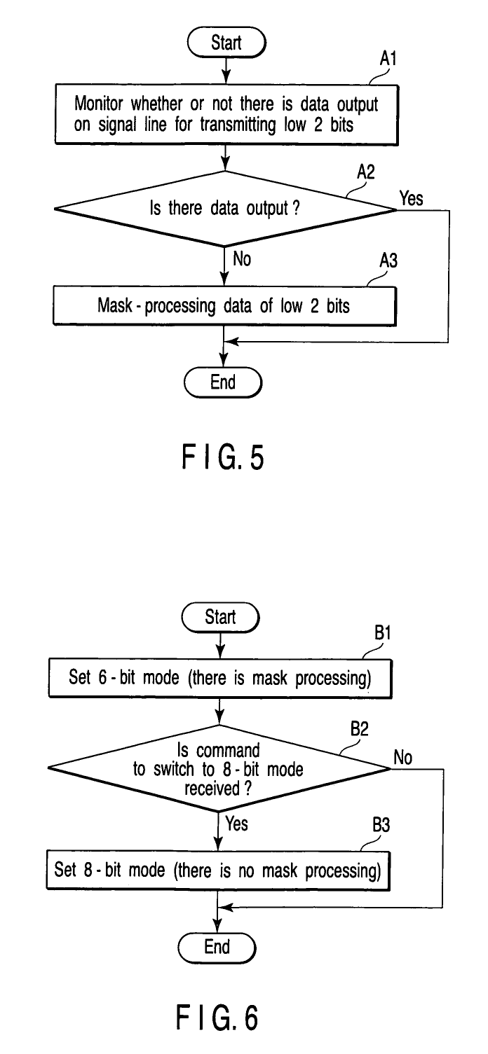

FIG. 5 is an exemplary flowchart showing operational procedures relating to data display of the computer 10.

With respect to the display data outputted from the graphics controller 104 of the computer main unit 11, the IF control circuit 106 of the display unit 12 monitors whether or not there is data output onto the 2nd RGB IF signal line 202 for transmitting and receiving the low 2 bits thereof in accordance with a signal level of the CNT signal line 203 (block A1).

Then, when a signal level of the CNT signal line 203 is Low, i.e., there is data output (YES in block A2), the IF control circuit 106 of the display unit 12 relays to the LVDS LSI 105 the data on the 2nd RGB IF signal line 202 so as to have the value as is, i.e., does not do anything. On the other hand, when a signal level of the CNT signal line 203 is OPEN, i.e., there is no data output (NO in block A2), the IF control circuit 106 of the display unit 12 executes mask processing for fixing data of the low 2 bits supplied to the LVDS LSI 105 to 0 (block A3).

By the way, in the above description, the example has been described in which it is determined whether the IF control circuit 106 carries out mask processing or not by monitoring a signal level on the CNT signal line 203, i.e., the IF control circuit 106 is operated in a 6-bit mode or in an 8-bit mode. However, it is easy to modify the example such that the determination is carried out in response to a command from the graphics controller 104.

In this case, for example, immediately after the computer 10 is turned on, it operates in a 6-bit mode as an initial state, and it is switched to operations in an 8-bit mode in timing of receiving a command from the graphic controller 104. In this way, it suffices for, for example, the old-model computer main unit 11 to directly output display data in 6-bit gradation in each color without issuing the command, and it suffices to add a procedure of issuing the command in the new type of computer main unit 11 which outputs display data in 8-bit gradation in each color. FIG. 6 is an exemplary flowchart showing operational procedures relating to data display in this case.

The IF control circuit 106 of the display unit 12 first sets a 6-bit mode in which mask processing is executed for fixing data of the low 2 bits supplied to the LVDS LSI 105 to 0 (block B1). Thereafter, when a command for instructing to switch to an 8-bit mode is issued from the graphics controller 104 of the computer main unit 11 (YES in block B2), the IF control circuit 106 of the display unit 12 executes switching to an 8-bit mode in which the mask processing is not executed (block B3).

As described above, according to the information processing apparatus of the present embodiment, it is possible to correspond to both of, for example, an interface for transmitting and receiving display data in 6-bit gradation in each color, and an interface for transmitting and receiving display data in 8-bit gradation in each color.

While certain embodiments of the inventions have been described, these embodiments have been presented by way of example only, and are not intended novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the invention.

What is claimed is:

1. A display apparatus comprising:
an input unit configured to input any one of display data in m-bit gradation in each color and display data in n(m>n)-bit gradation in each color;
a display control unit configured to execute display control of display data inputted by the input unit in m-bit gradation in each color;
a determination unit configured to determine whether the display data inputted by the input unit is in m-bit gradation in each color or in n-bit gradation in each color; and
a mask unit configured to execute mask processing with respect to the display data in n-bit gradation in each color, and
the determination unit controlling the display data in n-bit gradation in each color as the display data in m-bit gradation in each color, when the display data is determined to be in n-bit gradation in each color by the determination unit.

2. The display apparatus according to claim 1, wherein the determination unit detects whether or not there is display data output onto (m-n) signal lines among m signal lines provided to transfer the display data inputted by the input unit to the display control unit, and determines it to be in m-bit gradation in each color when display data is outputted and determines it to be in n-bit gradation in each color when display data is not outputted.

3. The display apparatus according to claim 2, wherein the determination unit detects whether or not there is display data output onto (m-n) signal lines to transfer display data of low (m-n) bits among m bits.

4. The display apparatus according to claim 2, wherein the determination unit detects whether or not there is display data output onto the (m-n) signal lines by monitoring a control signal line provided to detect whether or not there is display data output onto the (m-n) signal lines.

5. The display apparatus according to claim 2, wherein the mask unit fixes (m-n) signal lines among m signal lines provided to transfer the display data inputted by the input unit to the display control unit in a predetermined state, as the mask processing.

6. The display apparatus according to claim 5, wherein the mask unit intends (m-n) signal lines to transfer display data of low (m-n) bits among m bits for the mask processing.

7. The display apparatus according to claim 5, wherein the mask unit fixes the (m-n) signal lines to set a value of each item of display data to be zero.

8. An information processing apparatus composed of a display apparatus and a main unit device which carries out data display by using the display apparatus, comprising:
the display apparatus including:
a connection unit including m input/output terminals;
a display control unit configured to execute display control of display data in m-bit gradation in each color;
a mask unit configured to execute mask processing with respect to display data in n(m>n)-bit gradation in each color; and
a control unit configured to activate the mask processing by the mask unit at the time of turning power-on in order to control the display data in n-bit gradation in each color inputted via the connection unit as the display data in m-bit gradation in each color, and to stop the mask processing by the mask unit when a command to give notice of that display data to be supplied is in m-bit gradation is received from the main unit device.

9. The information processing apparatus according to claim 8, wherein the main unit device includes:
a connection unit including m input/output terminals; and
a display control unit configured to output display data in m-bit gradation in each color by using the m input/output terminals included in the connection unit after a command to give notice of that display data to be supplied is in m-bit gradation in each color is transmitted to the display apparatus.

10. The information processing apparatus according to claim 8, wherein the main unit device further includes:
a connection unit including n input/output terminals which are made to correspond to n input/output terminals to input display data of high n bits out of m bits, among the m input/output terminals included in the connection unit at the display apparatus; and
a display control unit configured to output display data in n-bit gradation in each color by using the n input/output terminals included in the connection unit.

11. The information processing apparatus according to claim 8, wherein the mask unit of the display apparatus intends (m-n) signal lines provided to transfer display data of low (m-n) bits out of m bits from the connection unit to the display control unit, for the mask processing.

12. The information processing apparatus according to claim 8, wherein the mask unit of the display apparatus fixes the (m-n) signal lines to set a value of each item of display data to be zero.

13. A method for controlling a display apparatus, comprising:
determining whether display data to be transmitted and received via m signal lines is in m-bit gradation in each color or in n (m>n)-bit gradation in each color; and
fixing to a predetermined value display data on (m-n) signal lines to transfer display data of low (m-n) bits out of m bits among the m signal lines, when display data is determined to be in n-bit gradation in each color.
